(19) United States
(12) Patent Application Publication
(10) Pub. No.: US 2026/0167431 A1
(43) Pub. Date: Jun. 18, 2026

(54) PACKAGE CONVEYOR SYSTEM

(71) Applicant: System Logistics Corporation, Arden, NC (US)

(72) Inventors: Matthew Roberts, Clemmons, NC (US); John Barnett, Pisgah Forest, NC (US); Luis Guillen, Arden, NC (US); Steven Barnett, Flat Rock, NC (US)

(73) Assignee: System Logistics Corporation, Arden, NC (US)

(21) Appl. No.: 18/985,862

(22) Filed: Dec. 18, 2024

(51) Int. Cl. B65G 39/12

(52) U.S. Cl. CPC B65G 39/12; B65G 2201/0235

(57) ABSTRACT

A package conveyor system has one or more accumulation sections (402). An accumulation section has conveyor rollers (502), first and second accumulation subsections (402A1, 402A2), a driven roller (518) positioned between the accumulation subsections, a drive belt (516), a selectably-activated motor (520), and at least one belt tensioning device (512). An accumulation subsection has movable frames (506), idler rollers (508, 510) held in place by the movable frames, and actuators (514) connected to the movable frames. The drive belt is in contact with the idler rollers, the belt tensioning device, and the driven roller, with the drive belt being urged into contact with a first set of conveyor rollers when a first actuator is in a first position, and removed from contact with the first set of conveyor rollers when the first actuator is in a second position. An accumulation subsection may be driven, free-rolling, or braked.

### BACKGROUND

Conveyors are used to transport packages from, for example, one area of a processing building to another area or to a loading area. When the packages have different sizes, however, undesirably large gaps may occur between packages, thereby reducing the storage density, i.e., the number of packages that can reside on the conveyor, and some techniques for increasing the storage density result in excessive force being applied to the package, thereby damaging the product in the package, and/or the package being prematurely pushed through the end of the conveyor onto another conveyor, thereby causing jams, delays, and/or product damage.

### SUMMARY

A package conveyor system has: a main frame; a plurality of conveyor rollers held in place by the main frame; an accumulation section having first and second accumulation subsections, each accumulation subsection having a movable frame being at least partially within the main frame, idler rollers held in place by the movable frame, and an actuator connected to the movable frame; at least one belt tensioning device; a driven roller positioned between the first accumulation subsection and the second accumulation subsection; a drive belt in contact with the idler rollers, the belt tensioning device, and the driven roller; and a selectably-activated motor to drive the driven roller.

The belt tensioning device maintains the drive belt in a desired state of tension.

The drive belt is urged into contact with a first set of conveyor rollers when a corresponding actuator is in a first position, and the drive belt is removed from contact with the first set of conveyor rollers when the corresponding actuator is in a second position.

The belt tensioning device may be included in an accumulation subsection, and each accumulation section may have a belt tensioning device.

Each accumulation subsection may be driven, may be free-rolling, or may be braked, as desired.

Both accumulation subsections may be driven simultaneously.

Both accumulation subsections may be braked simultaneously.

Both accumulation subsections may be free-rolling simultaneously.

One accumulation subsection may be driven while the other accumulation subsection is driven or free-rolling.

One accumulation subsection may be free-rolling while the other accumulation subsection is driven, free-rolling, or braked.

One accumulation subsection may be braked while the other accumulation subsection is free-rolling or braked.

### BRIEF DESCRIPTION OF THE DRAWING

FIG. 1 is an oblique view of an exemplary package conveyor system showing an accumulation area and a discharge section.

FIG. 2 is a top view of the exemplary package conveyor system showing the accumulation area and the discharge section.

FIG. 3 is a side view of the exemplary package conveyor system showing the accumulation area, the discharge section, and the main frame.

FIG. 4 is a cutaway side view along line A-A of FIG. 1 of the exemplary package conveyor system.

FIG. 5 is a cutaway side view along line B-B of FIG. 4 of the exemplary package conveyor system.

FIG. 6 is a cutaway side view along line C-C of FIG. 4 of the exemplary package conveyor system.

FIG. 7 is a top view of the exemplary package conveyor system showing photo-electric sensors.

### DETAILED DESCRIPTION

The following Detailed Description is directed to a package conveyor system. In this Detailed Description references are made to the accompanying drawings, which form a part hereof, and that show by way of illustration various configurations or examples of the present disclosure. Referring now to the drawings, wherein like numerals represent like elements throughout the several figures, various aspects of the package conveyor system are presented.

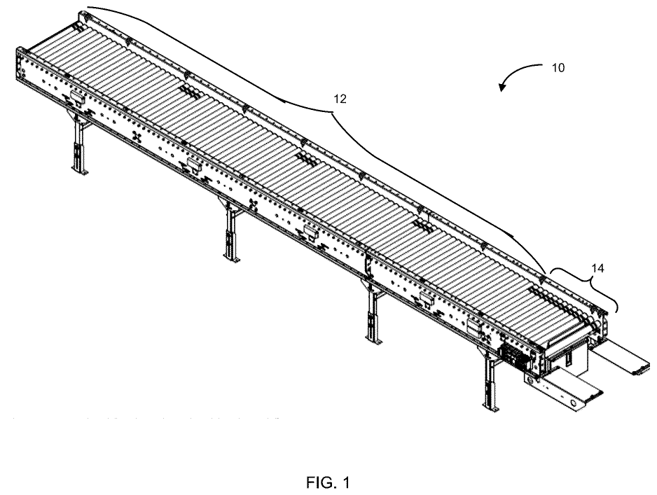

FIG. 1 is an oblique view of an exemplary package conveyor system 10 showing an accumulation area 12 and a discharge section 14.

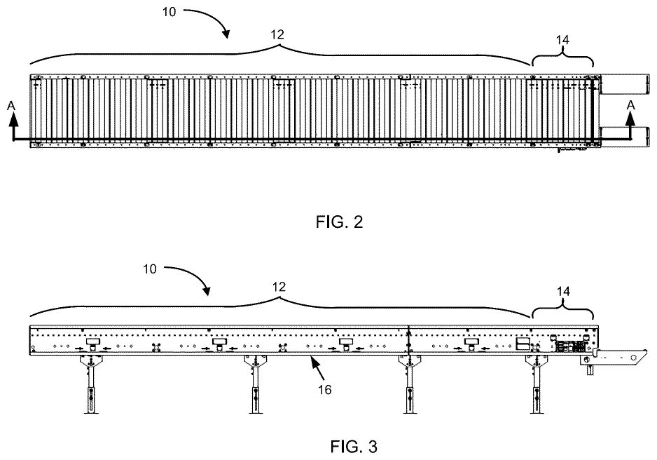

FIG. 2 is a top view of the exemplary package conveyor system 10 showing the accumulation area 12 and the discharge section 14.

FIG. 3 is a side view of the exemplary package conveyor system 10 showing the accumulation area 12, the discharge section 14, and the main frame 16.

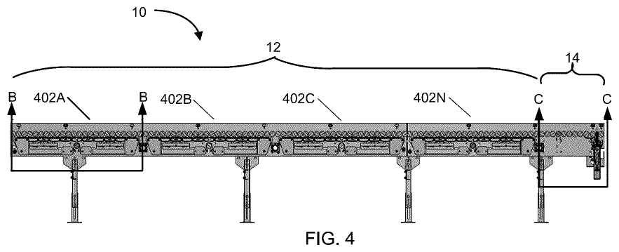

FIG. 4 is a cutaway side view along line A-A of FIG. 1 of the exemplary package conveyor system 10 showing the accumulation area 12 and the discharge section 14. The accumulation area 12 consists of several accumulation sections 402A, 402B, 402C, . . . 402N, sometimes referred to herein individually as an accumulation section 400, or collectively as accumulation sections 400.

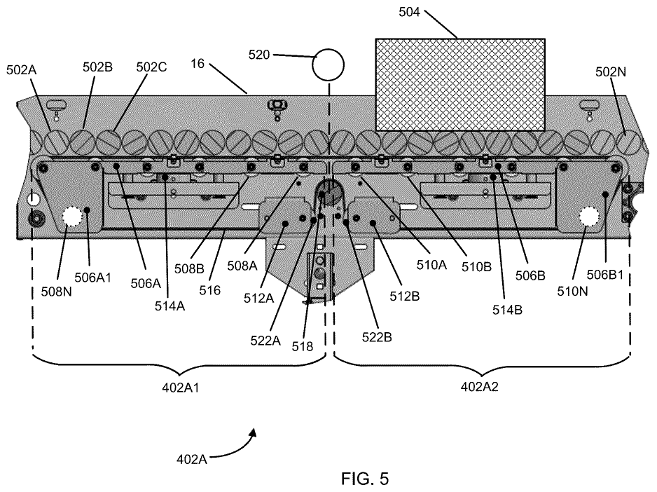

FIG. 5 is a cutaway side view along line B-B of FIG. 4 of the exemplary package conveyor system 10. The main frame 16 holds a plurality of conveyor rollers 502A, 502B, 502C, . . . 502N in place, sometimes referred to herein individually as a conveyor roller 500, or collectively as conveyor rollers 500. An exemplary package 504 rests upon and is moved by the conveyor rollers 500. The main frame 16 may be a single frame or, if needed, may be two or more frames connected in series.

An accumulation section 400, such as accumulation section 402A, preferably has two accumulation subsections, 402A1, 402A2.

Accumulation subsections 402A1 and 402A2 have movable frames 506A and 506B, respectively. Moveable frames 506A and 506B may sometimes be referred to herein individually as a movable frame 506, or collectively as movable frames 506.

Movable frames 506A and 506B have a plurality of idler rollers 508A, 508B, . . . 508N, and 510A, 510B, . . . 510N, respectively. Rollers 508A, 508B, ... 508N, and 510A, 510B, . . . 510N may sometimes be referred to herein individually as an idler roller 508, 510, respectively, or collectively as idler rollers 508, 510, respectively. Rollers 508N and 510N are hidden in this view by plates 506A1 and 506B1, respectively, of movable frames 506A and 506B, respectively.

Accumulation subsections 402A1 and 402A2 also have actuators 514A, 514B, respectively, which can urge movable frame 506A, 506B, respectively, upward so that the drive belt 516 is in contact with the portion of the conveyor rollers 502 above that particular accumulation subsection 402A1, 402A2, or downward so that the drive belt 516 is not in contact with that portion of the conveyor rollers 502.

An accumulation section 400, such as accumulation section 402A, also has a driven roller 518 which is in contact with the drive belt 516, and which is selectably driven by a motor 520. Thus, the motor 520, through the driven roller 518, can drive or brake the drive belt 516.

Movable frames 506A, 506B also have respective belt tensioning devices 512A, 512B, which maintain the drive belt 516 in a desired state of tension as the actuators 514A, 514B move the movable frames 506 upward or downward.

In an implementation, the belt tensioning devices 512A, 512B are manually adjusted.

In another implementation, the belt tensioning devices 512A, 512B may be automatic devices, for example, rollers 522A, 522B which are biased by springs in a predetermined direction. Preferably, only the downstream tensioning device is spring-loaded.

Two belt tensioning devices 512A, 512B are shown as that allows for a single design for both accumulation section 402A and accumulation section 402B, with the sections 402A, 402B facing each other but, preferably, with only the downstream tensioning device being spring-loaded.

In another implementation, one belt tensioning device 512 is a static device, and the other belt tensioning device 512 is a dynamic device, such as a spring-loaded dynamic tensioner on the downstream side of the driven roller 518.

The actuators 514A, 514B, and the motor 520, are individually controllable.

Consider now the various modes of operation of an accumulation section 400, such as accumulation section 402A. If the actuator 514A urges the drive belt 516 into contact with the conveyor rollers 502 above accumulation subsection 402A1, and the motor 520 is activated, then the conveyor rollers 502 above accumulation subsection 402A1 will be driven and move the package 504 toward the discharge section 14.

If the actuator 514A urges the drive belt 516 into contact with the conveyor rollers 502 above accumulation subsection 402A1, and the motor 520 is de-activated, then the conveyor rollers 502 above accumulation subsection 402A1 will be braked to stop movement of the package 504.

If the actuator 514A moves the drive belt 516 away from contact with the conveyor rollers 502 above accumulation subsection 402A1 then the conveyor rollers 502 above accumulation subsection 402A1 will be free-rolling and the package 504 will neither be driven nor braked.

Accumulation subsection 402B acts in a similar manner.

Thus, (a) both accumulation subsections 402A1, 402A2 may be driven, (b) both accumulation subsections 402A1, 402A2 may be braked, (c) both accumulation subsections 402A1, 402A2 may be free-rolling, (d) one accumulation subsection, e.g., 402A, may be driven while the other accumulation subsection, e.g., 402B, is free-rolling, or (e) one accumulation subsection, e.g., 402A, may be braked while the other accumulation subsection, e.g., 402B, is free-rolling.

With these multiple functionalities, each accumulation section 402 and subsection 402A can precisely control the type of accumulation that is occurring in order to have maximum package 504 density (no spaces between packages 504) while also achieving low line pressure of packages 504 being undesirably driven and pushing other packages 504 downstream.

It will be noted that the movement of package 504 is opposite of the direction of movement of the portion of belt 516 nearer the conveyor rollers 502. That is, if belt 516 is moving in a counterclockwise direction, as viewed on the drawing, then the movement of the package 504 will be toward the right side of the page.

In an implementation, each accumulation section 402, such as accumulation section 402A, has two accumulation subsections, such as accumulation subsections 402A1 and 402A2. There may be more accumulation subsections in an accumulation section 402 if desired.

In an implementation, an actuator 514 is a pneumatic device.

In another implementation, an actuator 514 is an electrically-operated device.

In an implementation, each accumulation section 402, such as accumulation section 402A, has a length of approximately four (4) feet, but may be longer or shorter, if desired.

In an implementation, each accumulation section 402, such as accumulation section 402A, has a length of approximately four (4) feet, and each accumulation subsection, such as accumulation subsections 402A1 and 402A2, have a length of approximately two (2) feet, but may be longer or shorter, if desired.

In an implementation, motor 520 is a 24-volt DC (VDC) motor. The use of a 24 VDC motor and drive allows a cost-effective solution of shorter lanes where a single AC gear motor and controls would be cost prohibitive. Also, the use of a 24 VDC motor for each accumulation section 402 provides for convenient independent multiple zone control. Further, the design of the individually driven accumulation sections and subsections allows great flexibility in the length of the package conveyor system 10 requiring without major design or programming changes.

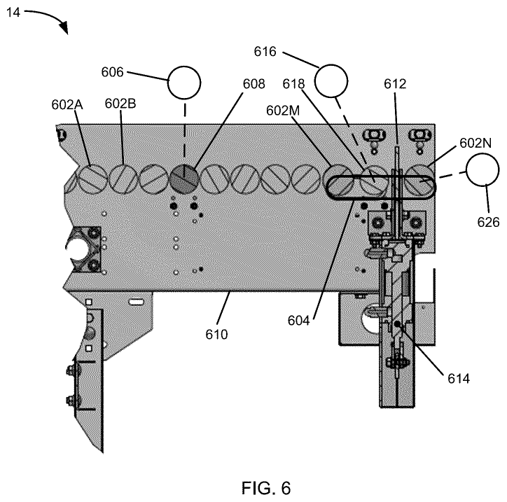

FIG. 6 is a cutaway side view along line C-C of FIG. 4 of the exemplary package conveyor system 10 showing the discharge section 14. The discharge section 14 is at the end of the conveyor system 10 and discharges the package 504 off of this specific conveyor system 10, and onto another conveyor system moving packages in a perpendicular direction. The discharge section 14 has a plurality of conveyor rollers 602A, 602B, . . . 602N, a drive band 604, drive motors 606, 616, driven rollers 608, 618, a frame 610, a blade stop 612, and a blade stop actuator 614. Conveyor rollers 602A, 602B, . . . 602N may sometimes be referred to herein individually as a conveyor roller 602, or collectively as conveyor rollers 602.

In an implementation, the blade stop 612 is selectively extended upwardly between two conveyor rollers 602, such as conveyor rollers 618 and 602N, to block the movement of a package 504, by operation of the blade stop actuator 614, so that a single package is discharged for each release. If desired, however, the blade stop actuator 614 could be operated so that two or more packages are discharged for each release.

Drive motor 606 drives driven roller 608, and drive motor 616 drives driven roller 618.

In an implementation, the drive band 604, such as an O-ring band, couples rollers 602M, 618, and 602N. Thus, when drive motor 616 is activated, rollers 602M, 618, and 602N turn to move the package 504.

In another implementation, drive band 604 couples rollers 602M and 618, and roller 502N is driven by another drive motor 626.

Although only a single blade stop 612 is shown, additional blade stops 612 may be used, such as between accumulation sections 402 or between accumulation subsections, such as 402A1, 402A2, as desired so as to achieve the preferred level of package 504 control and bunching.

When a package is to be discharged the controller 702 activates the discharge section 14 by retracting the blade stop 612 and, by activating or increasing the speed of motors 616, and/or 626, a single package 504 is pulled away from the other packages 504 in the package conveyor system 10 and a gap is created by the speed change that occurs in rollers 602M, 618, and/or 602N. This product is moved from the package conveyor system 10 and onto another outbound conveyor system traveling perpendicular to the lane. In the gap between the packages 504 created by the speed change the blade stop 612 is activated, stopping any other packages 504 from moving to the outbound conveyor system.

The use of two or three drive motors 606, 616, 626 and the blade stop 612 in the discharge section 14 allows precise control of the movement and position of a package 504. For example, if the blade stop 612 is lowered, drive motor 616 could begin moving the package 504 but, when the package 504 moved over conveyor roller 602M, drive motor 616 could be activated, thereby turning conveyor rollers 602M and 618 (and 602N) at a higher rate, thereby pulling the package 504 away from other packages 504 in the accumulation area 12 and the discharge section 14. Further, as the package 504 is exiting the discharge section 14, drive motor 626 can be activated so that conveyor roller 602N pushes the package 504 completely off of the discharge 14 and onto, for example, another package conveyor (not shown).

The blade stop 612 allows high speed discharge with precise control over each package 504 dispensed so as not to have multiple packages 504 move onto the outbound conveyor system, thereby preventing a jam, a false release, or an unintended multiple package 504 release.

In an implementation, one, two, or all motors 606, 616, 626 is a 24-volt DC motor.

In an implementation, frame 610 is a continuation or extension of frame 16.

In an implementation, blade stop actuator 614 is a pneumatic device.

In another implementation, blade stop actuator 614 is an electrically-operated device.

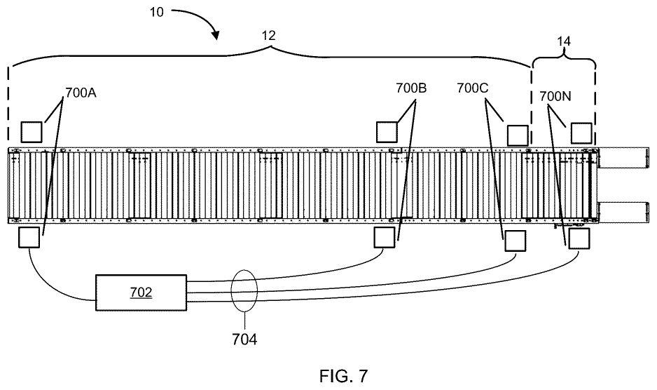

FIG. 7 is a top view of the exemplary package conveyor system 10 showing photo-electric sensors 700A, 700B, 700C, . . . 700N. Photo-electric sensors 700A, 700B, 700C, . . . 700N may sometimes be referred to herein individually as a photo-electric sensor 700, or collectively as photo-electric sensors 700.

Photo-electric sensors 700 are connected via signal lines 704 to a controller 702 to control the movement of packages 504 on the package conveyor system 10. The number and placement of the photo-electric sensors 700 in the drawing is arbitrary as the actual number and actual placement would depend upon the particular processing requirements for the particular packages 504 being handled.

The photo-electric sensors 700 detect any gaps between packages 504 and/or a change in state (movement) of a package 504. If either of these conditions is detected the controller 702 activates an accumulation function, activating the accumulation sections 402 in different sequences to move all the packages 504 together, thus eliminating gaps and providing for maximum accumulation density.

The photo-electric sensors 700 provide information about the location of the packages 504 on the package conveyor system 10 so that the controller 702 can determine which actuators 514 to enable or disable, which motors 520, 606 to turn on or off, and which blade stop actuators 614 to enable or disable. For example, if a photo-electric sensor 700 does not detect a package 504 in the discharge area 14 then the controller 702 may activate one or more accumulation sections 402 to move a package 504 to the discharge section 14.

If, however, a photo-electric sensor 700 does detect a package 504 in the discharge area 14 then the controller 702 may act to prevent more packages 504 from being pushed onto the discharge area 14 such as, by example, turning off one or more motors 520 and activating one or more actuators 514 to brake one or more accumulation sections or subsections so that packages 504 are not pushed forward, and/or by turning off one or motors 520 and de-activating one or more actuators 514 so that free-rolling is enabled and the packages 504 coast or are gravity-fed until they reach a blade stop 612 or come into non-driven contact with a preceding package 504.

Similarly, the accumulation area 12 may be gently filled with packages 504. For example, if a photo-electric sensor 700 detects that a specific accumulation section 402 is empty, or not full, then the controller 702 may act to activate a motor 520 and one or both actuators 514 in preceding (upstream) accumulation sections 402 to cause packages 504 to be transported downstream. As a package 504 nears the specific accumulation section 402 the controller 702 may act to de-activate the motor 520 and/or de-activate one or more actuators 514 so the package 504 is stopped (braked) or just allowed to free-roll until it contacts a blade stop 612 or comes into non-driven contact with a preceding package 504. This process can be repeated, if desired, until the discharge section 14, and one to all accumulation sections 402, have been filled to the desired level, all without packages 504 being forcefully pressed against each other, and without gaps between the packages 504.

Thus, a desired level of bunching of packages 504 may be obtained without excessive (damaging) pressure or contact between the packages 504.

Further, the use of short subsections 402A1, 402A2 allows for more precise control than the use of long or full sections, such as ten-foot sections.

The package conveyor system 10 can accumulate products of varying sizes with no gap but limited line pressure and dispense rapidly and repeatably onto a perpendicular outbound conveyor system.

Thus, the package conveyor system 10 provides a horizontal queueing conveyor to handle varying package 504 sizes and accumulate them with no gap for maximum storage density over an extended length without generating line pressure that would cause damage to packages 504 or push packages 504 through the end of the discharge area of the conveyor.

Also, the package conveyor system 10 accumulates packages 504 with zero gap, regardless of the various sizes of the packages 504, and dispenses the packages 504 onto an outbound conveyor which is perpendicular to the package conveyor system 10.

In an implementation, the package conveyor system 10 can move and discharge packages 504 of various sizes individually, and at a minimum rate of 1200 packages (units) per hour.

In an implementation, the package conveyor system 10 is driven by 24VDC motors in order to be economical in short sections.

The package conveyor system 10 also provides the capability of being extended in length as needed by adding more accumulation sections 402.

In the package conveyor system 10 the products are allowed to touch and bump but are at zero-pressure accumulation after they stop.

In an implementation, the accumulation area 12 operates at a belt speed of 60 feet per minute (FPM) and the discharge section 14 operates at a speed of 180 FPM.

In an implementation, the minimum speed for dense packing of packages 504 is 90 FPM for totes and 125 FPM for corrugated products.

In an implementation, the product-carrying conveyor rollers 502 are driven by a nominal 1.75″ wide belt 516.

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations may be well known in the art, and because they do not facilitate a better understanding of the present disclosure, a discussion of such elements and operations is not provided herein. The present disclosure is deemed to inherently include all such elements, variations, and modifications to the described aspects that would be known to those of ordinary skill in the art, particularly in view of reading the present disclosure.

The terminology used herein is for the purpose of describing particular example embodiments or implementations only and is not intended to be limiting. As used herein, the singular forms “a”, “an”, and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

The terms “includes,” “has,” “having,” or “exhibits,” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, “around”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the embodiment(s) disclosed herein may be used individually or in combination with one, some or possibly even all of the other benefits. Furthermore, not every embodiment, nor every component of an embodiment, is necessarily required to obtain, or necessarily required to provide, one or more of the advantages and benefits of the embodiment.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every embodiment.

The subject matter described herein is provided by way of illustration only and should not be construed as limiting the nature and scope of the claims herein. While different embodiments have been provided above, it is not possible to describe every conceivable combination of components or methodologies for implementing the disclosed subject matter, and one of ordinary skill in the art may recognize that further combinations and permutations that are possible. Furthermore, the nature and scope of the claims is not necessarily limited to embodiments that solve any or all disadvantages which may have been noted in any part of this disclosure. Various modifications and changes may be made to the subject matter described herein without following, or departing from the spirit and scope of, the exemplary embodiments and applications illustrated and described herein. Although the subject matter presented herein has been described in language specific to components used therein, it is to be understood that the scope of the claims is not necessarily limited to the specific components or characteristics thereof described herein; rather, the specific components and characteristics thereof are disclosed as example forms of implementing the disclosed subject matter. Accordingly, the disclosed subject matter is intended to embrace all alterations, modifications, and variations, that fall within the scope and spirit of any claims that may be written therefor.

1. A package conveyor system, comprising:
a main frame;
a plurality of conveyor rollers held in place by the main frame;
an accumulation section comprising a first accumulation subsection, a second accumulation subsection, a driven roller, a drive belt, and a selectably-activated motor;
the first accumulation subsection comprising:
a first movable frame, the first movable frame being at least partially within the main frame;
a first plurality of idler rollers held in place by the first movable frame;
a first actuator connected to the first movable frame; and
the second accumulation subsection comprising:
a second movable frame, the second movable frame being at least partially within the main frame;
a second plurality of idler rollers held in place by the second movable frame;
a second actuator connected to the second movable frame; and
a belt tensioning device;
the driven roller being positioned between the first accumulation subsection and the second accumulation subsection;
the drive belt being in contact with the first plurality of idler rollers, the second plurality of idler rollers, the belt tensioning device, and the driven roller, wherein the belt tensioning device maintains the drive belt in a desired state of tension; and
the selectably-activated motor drives the driven roller;
wherein the drive belt is urged into contact with a first set of conveyor rollers of the plurality of conveyor rollers when the first actuator is in a first position, and the drive belt is removed from contact with the first set of conveyor rollers when the first actuator is in a second position; and
wherein the drive belt is urged into contact with a second set of conveyor rollers of the plurality of conveyor rollers when the second actuator is in a first position, and the drive belt is removed from contact with the second set of conveyor rollers when the second actuator is in a second position.

2. The package conveyor system of claim 1, wherein:
the first set of conveyor rollers is driven when the first actuator is in the first position and the motor is activated.

3. The package conveyor system of claim 1, wherein:
the first set of conveyor rollers is braked when the first actuator is in the first position and the motor is not activated.

4. The package conveyor system of claim 1, wherein:
the first set of conveyor rollers freerolls when the first actuator is in the second position.

5. The package conveyor system of claim 1, wherein:
the first accumulation subsection has a length of approximately two feet.

6. The package conveyor system of claim 1, wherein:
the selectably-activated motor is a 24 VCD motor.

7. The package conveyor system of claim 1, further comprising:
a plurality of accumulation sections.

8. The package conveyor system of claim 1, wherein:
the main frame comprises a plurality of main frame sections each main frame section holding at least some of the conveyor rollers in place.

9. The package conveyor system of claim 1, further comprising:
a discharge section, the discharge section comprising:
a discharge section frame;
a portion of the conveyor rollers;
a discharge section motor, the discharge section motor selectably driving at least one of the conveyor rollers of the portion of conveyor rollers; and
a blade stop actuator to selectively extend a blade stop between two conveyor rollers of the portion of conveyor rollers;
wherein a blade stop may be selectively extended to block movement of a package on the discharge section.

10. The package conveyor system of claim 9, wherein:
the discharge section frame is a continuation of the main frame.

11. The package conveyor system of claim 1, further comprising:
a plurality of accumulation sections, wherein an accumulation subsection of a first accumulation section of the plurality of accumulation sections is operable independently of an accumulation subsection of a second accumulation section of the plurality of accumulation sections.

12. The package conveyor system of claim 11, wherein:
the accumulation subsection of the first accumulation section is driven when the accumulation subsection of the second accumulation section is braked.

13. The package conveyor system of claim 1:
wherein the belt tensioning device is a first belt tensioning device and is included in the first accumulation subsection;
and further comprising:
a second belt tensioning device included in the second accumulation subsection;
wherein the drive belt is also in contact with the second belt tensioning device.

14. A package conveyor system, comprising:
a main frame;
a plurality of conveyor rollers held in place by the main frame;
a plurality of accumulation sections, each accumulation section of the plurality of accumulation sections comprising a first accumulation subsection, a second accumulation subsection, a driven roller, a drive belt, and a selectably-activated motor;
the first accumulation subsection of an accumulation section comprising:
a first movable frame, the first movable frame being at least partially within the main frame;
a first plurality of idler rollers held in place by the first movable frame;
a first actuator connected to the first movable frame; and
the second accumulation subsection of the accumulation section comprising:
a second movable frame, the second movable frame being at least partially within the main frame;
a second plurality of idler rollers held in place by the second movable frame;
a second actuator connected to the second movable frame; and
a belt tensioning device;
the driven roller being positioned between the first accumulation subsection and the second accumulation subsection;
the drive belt being in contact with the first plurality of idler rollers, the second plurality of idler rollers, the belt tensioning device, and the driven roller, wherein the belt tensioning device maintains the drive belt in a desired state of tension; and
the selectably-activated motor drives the driven roller; and
a discharge section, the discharge section comprising:
a discharge section frame;
a portion of the conveyor rollers;
a discharge section motor selectably driving at least one of the conveyor rollers of the portion of conveyor rollers; and
a blade stop actuator to selectively extend a blade stop between two conveyor rollers of the portion of conveyor rollers;
wherein the drive belt is urged into contact with a first set of conveyor rollers of the plurality of conveyor rollers when the first actuator is in a first position, and the drive belt is removed from contact with the first set of conveyor rollers when the first actuator is in a second position;
wherein the drive belt is urged into contact with a second set of conveyor rollers of the plurality of conveyor rollers when the second actuator is in a first position, and the drive belt is removed from contact with the second set of conveyor rollers when the second actuator is in a second position; and
wherein a blade stop is selectively extended to block movement of a package on the discharge section.

15. The package conveyor system of claim 14, wherein:
the first set of conveyor rollers is driven when the first actuator is in the first position and the motor is activated.

16. The package conveyor system of claim 14, wherein:
the first set of conveyor rollers freerolls when the first actuator is in the second position.

17. The package conveyor system of claim 14:
wherein the belt tensioning device is a first belt tensioning device and is included in the first accumulation subsection;
and further comprising:
a second belt tensioning device included in the second accumulation subsection;
wherein the drive belt is also in contact with the second belt tensioning device.

18. The package conveyor system of claim 14, wherein:
the first accumulation subsection has a length of approximately two feet.

19. The package conveyor system of claim 14, wherein:
at least one of the selectably-activated motor or the discharge section motor is a 24 VDC motor.

20. A package conveyor system, comprising:
a main frame;
a plurality of conveyor rollers held in place by the main frame;
a plurality of accumulation sections, each accumulation section of the plurality of accumulation sections comprising a first accumulation subsection, a second accumulation subsection, a driven roller, a drive belt, and a selectably-activated motor, each accumulation subsection having a length of approximately two feet;
the first accumulation subsection of an accumulation section comprising:
a first movable frame, the first movable frame being at least partially within the main frame;
a first plurality of idler rollers held in place by the first movable frame;
a first actuator connected to the first movable frame; and
a first belt tensioning device;
the second accumulation subsection of the accumulation section comprising:
a second movable frame, the second movable frame being at least partially within the main frame;
a second plurality of idler rollers held in place by the second movable frame;
a second actuator connected to the second movable frame; and
a second belt tensioning device;
the driven roller being positioned between the first accumulation subsection and the second accumulation subsection;
the drive belt being in contact with the first plurality of idler rollers, the second plurality of idler rollers, the first belt tensioning device, the second belt tensioning device, and the driven roller, wherein the first and second belt tensioning devices maintain the drive belt in a desired state of tension; and
the selectably-activated motor being a 24 VDC motor and driving the driven roller; and
a discharge section, the discharge section comprising:
a discharge section frame;
a portion of the conveyor rollers;
a discharge section motor, the discharge section motor being a 24 VDC motor and selectably driving at least one of the conveyor rollers of the portion of conveyor rollers; and
a blade stop actuator to selectively extend a blade stop between two conveyor rollers of the portion of conveyor rollers;
wherein the drive belt is urged into contact with a first set of conveyor rollers of the plurality of conveyor rollers when the first actuator is in a first position, and the drive belt is removed from contact with the first set of conveyor rollers when the first actuator is in a second position;
wherein the drive belt is urged into contact with a second set of conveyor rollers of the plurality of conveyor rollers when the second actuator is in a first position, and the drive belt is removed from contact with the second set of conveyor rollers when the second actuator is in a second position;
wherein a blade stop is selectively extended to block movement of a package on the discharge section;
wherein the first set of conveyor rollers is driven when the first actuator is in the first position and the motor is activated;
wherein the first set of conveyor rollers is braked when the first actuator is in the first position and the motor is not activated; and
wherein the first set of conveyor rollers freerolls when the first actuator is in the second position.
